(19) United States
(12) Patent Application Publication
(10) Pub. No.: US 2015/0187351 A1
(43) Pub. Date: Jul. 2, 2015

(54) METHOD AND SYSTEM FOR PROVIDING USER WITH INFORMATION IN VEHICLE

(71) Applicant: Hyundai Motor Company, Seoul (KR)

(72) Inventor: Sung Hwan Moon, Hwaseong (KR)

(21) Appl. No.: 14/509,458

(22) Filed: Oct. 8, 2014

(30) Foreign Application Priority Data
Dec. 31, 2013 (KR) 10-2013-0167977

(51) Int. Cl. G10L 15/08

(52) U.S. Cl. CPC G10L 15/08

(57) ABSTRACT

A method and system for more accurately estimating and recognizing a user input for an information request using partial recognition results, collected user pattern information, and vehicle information when partial recognitions of the user input is detected are provided. In particular, user input information is analyzed with the vehicle information and user pattern information for more accurate estimation and recognition of the user input thus increasing recognition of the user input and providing the user requested information within the vehicle.

### CROSS-REFERENCE TO RELATED APPLICATION

This application claims under 35 U.S.C. §119(a) the benefit of Korean Patent Application No. 10-2013-0167977 filed on Dec. 31, 2013, the entire contents of which are incorporated herein by reference.

### BACKGROUND

(a) Technical Field

The present invention relates to a method and system for providing information, and more particularly to a system for recognizing a user request for information and providing information in response to the user request for information in a vehicle through a voice input, a manuscript, and an image input.

(b) Background Art

Today, development of multimedia technologies evolves into a comfortable vehicle and a convenient vehicle for providing a driver with infortainment (information and entertainment) then development of a vehicle leads to technologies for information transmission. Moreover, complexity of a vehicle and various driving patterns thereof require a driver to manipulate an increased number of devices while driving and demand more information from both within and extraneous to the vehicle and various types of information such as sound information, text information, graphical information, and image information, are provided to the driver.

A vehicle is often installed with various equipment for driver convenience such as a vehicle audio/video system and a vehicle navigation system that provides map information and traffic information. Recently, an audio-video-navigation (AVN) system, in which an audio device, a video device, and a navigation system are integrated, including a terminal that communicates with the inside and the outside of a vehicle is installed within a vehicle. This AVN system provides a driver with various drive-related information, location and map information required by the driver and media information such as audio and video in an audible or visual manner within the vehicle.

Meanwhile, a speech recognition function that allows executes a telephone call to be made using a voice input and performing various operations of a mobile terminal such as various functional controls of the mobile terminal and provision of user-demanded information, among the auxiliary functions of the mobile terminal, was previously developed for vehicles. The speech recognition is a technology for a machine, that is, a computer to recognize a voice signal by a human and to understand linguistic information contained in the voice signal to perform a required function. For example, a function of dialing a telephone number of the speech recognition functions extracts a corresponding phone number to automatically execute a phone call when a user inputs a speech input to a mobile terminal after storing phone numbers in a memory of the mobile terminal.

The speech recognition function is partially applied to vehicles. Recently, as the demand for driving information has increased, a speech recognition module has become associated with a vehicle terminal to allow the vehicle terminal to provide a driver with information based on a driver voice request recognized by the speech recognition module. However, the speech recognition accuracy of the speech recognition module of a vehicle is not satisfied yet. Since the speech recognition of a driver is affected even by internal and external circumferences of the vehicle, the driver's speech may not exactly be recognized and thus it may be difficult to provide the exact information requested by the driver. Moreover, the existing speech recognition module provides only the information requested by a driver but not useful supplementary information necessary for the driver while driving the vehicle.

### SUMMARY

The present invention provides a method and system for more accurately estimating and recognizing a user input for executing a request for information using partial recognition results, collected user pattern information, and vehicle information in the situations where only the partial recognitions of the user input is detected. The present invention also provides an information providing system for providing user requested information and supplementary information using data input by the user, user pattern information, and vehicle information when a user's voice input is generated to obtain necessary information from the vehicle, or when various types of a user input for the information such as a manuscript or a video input are input.

In accordance with an aspect of the present invention, a system for providing information in a vehicle comprising a multimedia recognition system for recognizing multimedia input data may include: a multimedia recognition module disposed within the vehicle and configured to deliver the multimedia input data; a vehicle information transmitter disposed within the vehicle and configured to deliver vehicle information; a multimedia recognition server configured to receive the multimedia input data transmitted from the multimedia recognition module via a multimedia relay server, extract recognizable information, and deliver extracted partially recognized result information; a user pattern-collecting server configured to collect and deliver user pattern information including mobile terminal user information, a vehicle terminal use information, or consuming pattern information of the user; and a user pattern-analyzing server configured to receive and analyze the partially recognized result information, the vehicle information, and the user pattern information to extract a final recognition result for the multimedia input and to transmit the extracted final recognition result such that the extracted final recognition result may be used in the vehicle.

Thus, the system for providing information in a vehicle according to the present invention may be configured to analyze user input information (e.g., partial recognition information of the user input) with the vehicle information and the user pattern information for more accurate estimation and recognition. Accordingly, recognition of user input may be improved and more accurate user requested information may be provided within the vehicle.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary block diagram illustrating a system according to an exemplary embodiment of the present invention; and

FIG. 2 is an exemplary flowchart illustrating a method of recognizing a user input request for information according to an exemplary embodiment of the present invention.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings. The detailed description of the invention will be provided for the purpose of explaining the principles of the invention and its practical application, thereby enabling others skilled in the art to understand the invention for various exemplary embodiments and with various modifications as are suited to the particular use contemplated. The detailed description is not intended to be exhaustive or to limit the invention to the precise embodiments disclosed. Modifications and equivalents will be apparent to practitioners skilled in this art and are encompassed within the spirit and scope of the appended claims.

The present invention relates to a system for providing information, and provides a system for recognizing a user request for information and providing the user with information within a vehicle in response to detecting the user request through a voice input, a manuscript, and an image input. In particular, the present invention provides a system configured to more accurately estimate and recognize a user input an information request using partial recognition results, user pattern information, and vehicle information when only the partial recognitions of the user input is detected.

The present invention is a technology to complement disadvantages of the existing user input recognition technologies, for example, a speech input and to analyze user's behaviors by collecting global positioning system (GPS) information of a mobile terminal, searched information in the mobile terminal, and credit card transaction information as well as to collect and analyze user input data (e.g., multimedia input data) and vehicle information for improved estimation of the most proper recognition results of the user input.

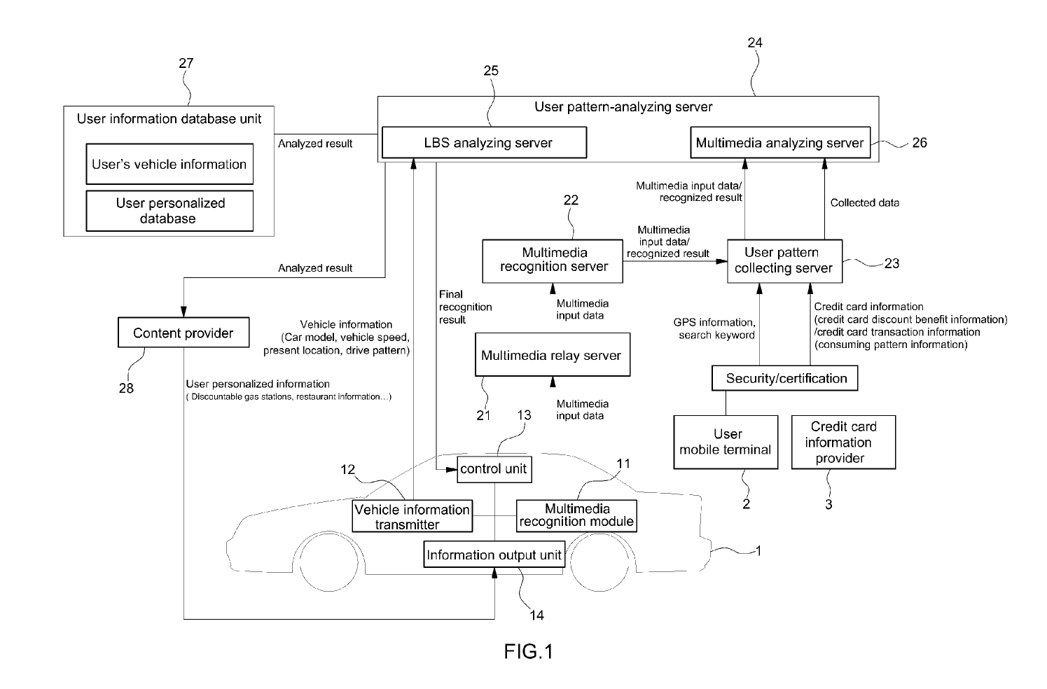

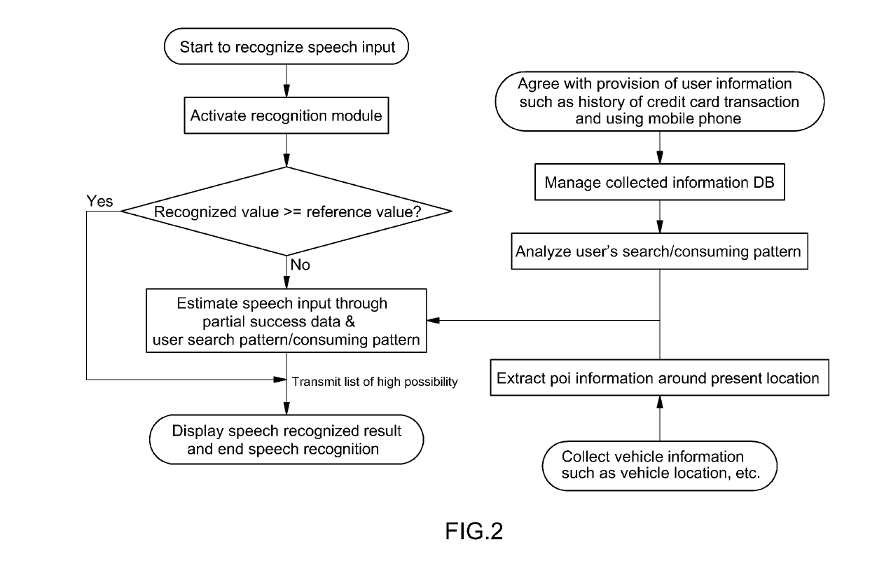

FIG. 1 is an exemplary block diagram illustrating a system according to an exemplary embodiment of the present invention and FIG. 2 is an exemplary flowchart illustrating a method of recognizing a user input for an information request according to an exemplary embodiment of the present invention.

Hereinafter, throughout the detailed description, a multimedia input may be a user input regarding a request for necessary information in a vehicle 1, that is, a user's input for an information request which may be a speech input through a speech input device such as a microphone or a speech recognition module, a manuscript input through a manuscript input device or a manuscript recognition module, or an image input through an imaging device or an image recognition module. Accordingly, the user input such as the speech input, the manuscript input, or the image input are may be referred to as a multimedia input throughout this detailed description. Additionally, user input data input in the form of the speech input, the manuscript input, or the image input may be referred to as input data and a module, such as a speech recognition module, a manuscript recognition module, and an image recognition module, of the vehicle 1 configured to recognize the multimedia input may be referred to as a multimedia recognition module 11.

First, the system for providing information according to an exemplary embodiment of the present invention may include a system for recognizing multimedia input data for an information request input by a user, that is, a multimedia recognizing system. Moreover, in the system, the multimedia recognizing system, as illustrated in FIG. 1, may include a multimedia recognizing module 11 disposed within the vehicle 1 and a vehicle information transmitter 12, and as an external system of the vehicle 1, a multimedia relay server 21, a multimedia recognizing server 22, a user pattern-collecting server 23, and a user pattern-analyzing server 24. In addition to the multimedia recognizing system, the system may further include a content providing unit 28 extraneous to the vehicle 1 and an information output unit 13 within the vehicle 1. These various units and modules may be executed by a controller having a processor and a memory.

The multimedia recognizing module 11, as described above, may include at least one of a speech recognition module, a manuscript recognition module, and an image recognition module and may be configured to perform a primary recognition for the multimedia input data when a user inputs a multimedia input (a speech input, a manuscript input, or an image input) for the information request. In particular, the multimedia recognition module 11 of the vehicle 1 may be configured to process the recognition result as a final recognition result when the multimedia input data is recognized as a recognition value greater than a reference value (e.g., recognition value>reference value).

In other words, the final recognition result may be displayed through an information output unit 13 according to the final recognition result and the requested information may be displayed via the information output unit 13 such as a speaker or a display of the vehicle 1. Particularly, the final recognition result may be one of recognition results or one selected by the user from a displayed list of a plurality of possible recognition results.

Moreover, when a partial recognition for the multimedia input data is determined as a recognition value less than a reference value (e.g., recognition value<reference value), the multimedia recognition module 11 of the vehicle 1 may be configured to transmit an output multimedia input data (e.g., raw data) via a wireless communication since the requested information may not be determined from the recognition result. In particular, the multimedia input data transmitted from the multimedia recognition module 11 of the vehicle 1 may be received at the multimedia recognition server 22, wherein the multimedia recognition server 22 may be configured to extract recognizable information from the multimedia input data, that is, the user input raw data to deliver the extracted partial recognition information (e.g., partial recognition-succeeding data) to the user pattern-analyzing server 24 via the user pattern-collecting server 23 or directly to the user pattern-analyzing server 24.

Moreover, the vehicle information transmitter 12 disposed within the vehicle 1 may be configured to transmit vehicle information such as a vehicle model, a vehicle speed, a present location, and a driving pattern to the user pattern-analyzing server 24 via a wireless communication. The user pattern-collecting server 23 may be configured to receive and collect the user patterns for the mobile terminal 2 and a credit card transaction from the user mobile terminal 2 or the credit card information provider 3. In particular, the user pattern-collecting server 23 may be configured to receive GPS information as location information of the mobile terminal 2 and search information such as a search keyword collected when the user performs a search through the mobile terminal 2 from the user mobile terminal 2.

The user pattern-collecting server 23 may be configured to receive information such as credit card discount benefit information and information regarding credit card use (e.g., credit card transaction information, that is, consumer's pattern information) including credit card payment information that indicates the a consumption pattern, from the credit card information provider 3. Although the user pattern information collected by the user pattern-collecting server 23 may be, for example, information regarding use of the mobile terminal 2 and a credit card, this information has been described only as an example of the user pattern information and the user pattern information is not limited to information regarding the use of the mobile terminal 2 and a credit card. In other words, the user pattern information collected by the user pattern-collecting server 23 may include use information of the mobile terminal 2 and a vehicle terminal, that is, search information in the vehicle terminal performed by a user, for example, a search history of information such as searched keyword or information for the information search collected when the search is performed at a portal site on the web.

Furthermore, the user pattern information collected by the user pattern-collecting server 23 may include history for information search through a user's mobile terminal, a vehicle terminal, a social networking site (SNS), SNS use information including information for the information search, information regarding a stock search performed by a user, or information regarding a music search performed by a user, and various user pattern-collecting sources such as the mobile terminal 2, the credit card information provider, and the vehicle terminal may be employed in the exemplary embodiment of the present invention.

The user pattern-collecting server 23 may be configured to deliver the data collected from the multimedia recognition server 22, the user mobile terminal 2, and the credit card information provider 3 to the user pattern-analyzing server 24. The user pattern-analyzing server 24 may be configured to analyze the data (e.g., partial recognition result information and user pattern information) delivered from the user pattern-collecting server 23 and the vehicle information delivered from the vehicle information transmitter 12 and determine a final recognition result for the user multimedia input to transmit the final result to the vehicle 1 via a wireless communication. Then, the multimedia recognition module 11 of the vehicle 1 may be configured to receive the final recognition result to display the results and to complete the recognition for the user multimedia input. The user requested information may then be output from the information output unit 13 of the vehicle 1.

During result determination process, the user pattern-analyzing server 24 may be configured to analyze the partial recognition result information, the user pattern information, and surrounding information of the present location extracted from the vehicle information such as the present location of the vehicle or point of interest (POI) information in the vicinity of the present location of the vehicle to obtain the final recognition result for the user multimedia input. The user pattern-analyzing server 24 may be configured to transmit the obtained final recognition result to the vehicle 1 and accumulate the collected information such as the vehicle information, the mobile terminal use information, and a credit card transaction information and the analyzed result information in a database unit 27.

Moreover, the final recognition result transmitted from the user pattern-analyzing server 24 to the vehicle 1 may be information in the form of a list including a plurality of recognition results analyzed and obtained based on the user pattern information. In particular, the vehicle 1 may be configured to receive the final recognition result in the form of a list and display the same on the information output unit 13, a result may be selected from the list to complete the recognition for the multimedia input.

For example, the user pattern-analyzing server 24 may be configured to analyze the vehicle information delivered from the vehicle information transmitter 12, to more accurately estimate and recognize the user multimedia input, the partial recognition result information (e.g., partial recognition success data) delivered via the user pattern-collecting server 23 (or directly delivered from the multimedia recognition server), and the user pattern information collected by the user pattern-collecting server 23. The user pattern information may include the search information and the GPS information as the mobile terminal use information and the consuming pattern information (e.g., credit card transaction information) such as the credit card discount benefit information and the credit card payment information.

In the system for providing information according to the exemplary embodiment of the present invention, the user pattern-analyzing server 24 may include a multimedia analyzing server 26 configured to analyze, as described above, the collected vehicle information, the partial recognition result information, and the user pattern information such as the mobile terminal use information and the consuming pattern information (credit card transaction information) to perform recognition for the user multimedia input and to transmit the estimated final recognition result to the vehicle 1 and a location-based service (LBS) analyzing server 25 configured to analyze the collected vehicle information and the collected user pattern information to obtain an analyzed result for provision of LBS.

The LBS-analyzing server 25 may be configured to analyze the collected vehicle information and the consuming pattern such as the user pattern information and deliver the analyzed result to the content provider 28 as a server of an associated service provider. Then, the content provider 28 may be configured to generate personalized information customized to an individual, that is, a user based on the user-analyzed result delivered from the LBS-analyzing server 25. The personalized information may be delivered to the vehicle 1 to output information useful to the user. In particular, the personalized information may be customized information useful to an individual user, such as information regarding coupons, discountable gas stations, restaurants, and the information reflected by the present location of the vehicle and the consuming pattern.

Accordingly, the user pattern-analyzing server 24, in association with the content provider 28 of the associated service provider, may be configured to deliver the personalized information obtained from the vehicle information and the user pattern information to the vehicle 1. The vehicle information and the user pattern information collected during this procedure and the result thereof and the personalized information may be stored in the database unit 27.

Although the user pattern-analyzing server 24 has been described to include the multimedia analyzing server 26 and the LBS-analyzing server 25, this is merely an example and the user pattern-analyzing server 24 is not limited to include the multimedia analyzing server 26 and the LBS-analyzing server 25 only. For example, in addition to the LBS-analyzing server 25, separate servers configured to collect and analyze the stock search, the music search, and the like may be added when the stock search, the music search, and the like are performed in the vehicle terminal or the user terminal 2 and a component. Accordingly, the results analyzed by the servers may be delivered to the content provider 28 for use when the content provider 28 generates the personalized information and transmits the generated personalized information.

FIG. 2 shows an exemplary method of recognizing a user input, using a speech input, as described above. The method may include comparing, by a controller, a recognition value with a reference value in response to detecting a speech input; extracting, by the controller, POI information regarding the present location of a vehicle, collecting, by the controller, user pattern information such as the credit card transaction information (e.g., consumption pattern information) and the mobile terminal use information (e.g., searched information, etc.), storing and analyzing, by the controller, the collected information in the database unit 27; analyzing, by the controller, the partial recognition result information (e.g., partial recognition success data) and the collected information to estimate content of the speech input and to transmit recognition result information in the form of a list to the vehicle; and displaying, by the controller, the speech recognition result to complete the speech recognition process.

As an example of the speech recognition, when a user inputs the coffee shop name “STARBUCKS” in vocal sound (e.g., via a microphone) and the multimedia recognition module 11 of the vehicle 1 recognizes only partially the speech input as “StarOO,” it may be possible for the user pattern-analyzing server 24 (multimedia analyzing server) to analyze the POI information of the present location of the vehicle and the user's consuming pattern information to estimate the speech input as “Starbucks.” When such a coffee shop is present in a nearby vicinity of the vehicle and a consumption pattern indicates that the user frequents such an establishment, the speech input may be estimated as “Starbucks.”

In another example, when there is a history of a user searching for “Sejong Center” and the multimedia recognition module 11 of the vehicle 1 recognizes the speech input as “OOO Center” partially, it may be possible for the user pattern-analyzing server 24 to estimate and recognize the speech input as “Sejong Center” from the user terminal use information. Accordingly, it may be possible to analyze the vehicle information and the user pattern information as well as the user input information and to more accurately estimate and recognize the user input.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A system for providing information in a vehicle that includes a multimedia recognition system for recognizing multimedia input data, the multimedia recognition system, comprising:
a memory configured to store program instructions; and
a processor configured to execute the program instructions, the program instructions when executed configured to:
receive the multimedia input data via a multimedia relay server;
receive vehicle information;
extract recognizable information from the multimedia input data and detect partially recognized result information from the extracted recognizable information;
collect user pattern information including mobile terminal user information, a vehicle terminal use information, and consumption pattern information; and
analyze the partially recognized result information, the vehicle information, and the user pattern information to extract a final recognition result for the multimedia input data and to transmit the extracted final recognition result.

2. The system of claim 1, wherein the multimedia input data includes any one of a speech input, a manuscript input, and an image input, and wherein manuscript input information is input via a manuscript input device; and image input information is input via an imaging device.

3. The system of claim 1, wherein the program instructions when executed are further configured to process a recognition result as a final recognition result when the multimedia input data is recognized as a recognized value greater than a reference value, and receive the multimedia input data when the multimedia input data is partially recognized as a recognized value less than a reference value.

4. The system of claim 1, wherein the program instructions when executed are further configured to analyze collected vehicle information and collected user pattern information to extract an analyzed result for providing a location-based service (LBS) or an analyzed result for providing a personalized information service and to deliver the analyzed result to a content provider that generates personalized information as customized information for an individual user based on the analyzed result and delivers the personalized information to the vehicle to be output.

5. The system of claim 4, wherein the vehicle information contains present location information of the vehicle, and information around the present location of the vehicle and the point of interest (POI) information around the present location of the vehicle is used in extraction of the final recognized result for the multimedia input data.

6. The system of claim 4, wherein mobile terminal user information as the user pattern information contains any one of global positioning system (GPS) location information of a mobile terminal and searched information in the mobile terminal containing a search keyword.

7. The system of claim 4, wherein vehicle terminal use information as the user pattern information includes searched information in a vehicle terminal containing a search keyword.

8. The system of claim 4, wherein consuming pattern information as user pattern information includes credit card transaction information provided from a credit card information provider.

9. The system of claim 8, wherein the consuming pattern information further includes credit card discount benefit information provided the credit card information provider.

10. A method for providing information in a vehicle that includes a multimedia recognition system for recognizing multimedia input data, the multimedia recognition method, comprising:
comparing, by a controller, a recognition value with a reference value in response to detecting a speech input;
extracting, by the controller, point of interest (POI) information regarding a present location of the vehicle,
collecting, by the controller, user pattern information and mobile terminal use information;
storing and analyzing, by the controller, the collected information in a database unit;
analyzing, by the controller, partial recognition result information and the collected information to estimate content of the speech input and output recognition result information as a list; and
displaying, by the controller, the speech recognition result.

11. The method of claim 10, wherein the mobile terminal user information contains any one of global positioning system (GPS) location information of a mobile terminal and searched information in the mobile terminal containing a search keyword.

12. The method of claim 10, wherein the user pattern information includes credit card transaction information provided from a credit card information provider.

13. A non-transitory computer readable medium containing program instructions executed by a controller, the computer readable medium comprising:
program instructions that compare a recognition value with a reference value in response to detecting a speech input;
program instructions that extract point of interest (POI) information regarding a present location of the vehicle,
program instructions that collect user pattern information and mobile terminal use information;
program instructions that store and analyze the collected information in a database unit;
program instructions that analyze partial recognition result information and the collected information to estimate content of the speech input and output recognition result information as a list; and
program instructions that display the speech recognition result.

14. The non-transitory computer readable medium of claim 13, wherein the mobile terminal user information contains any one of global positioning system (GPS) location information of a mobile terminal and searched information in the mobile terminal containing a search keyword.

15. The non-transitory computer readable medium of claim 13, wherein the user pattern information includes credit card transaction information provided from a credit card information provider.
